(19) United States
(12) Patent Application Publication
(10) Pub. No.: US 2025/0243945 A1
(43) Pub. Date: Jul. 31, 2025

(54) COMBINATION AIR RELEASE VALVE

(71) Applicant: MCWANE, INC.

(72) Inventor: Paul Kennedy, Horseheads, NY (US)

(21) Appl. No.: 19/040,835

(22) Filed: Jan. 29, 2025

Related U.S. Application Data
(60) Provisional application No. 63/626,263, filed on Jan. 29, 2024.

(51) Int. Cl. F16K 31/22; F16K 17/00

(52) U.S. Cl. CPC F16K 31/22; F16K 17/00

(57) ABSTRACT

A valve assembly for a combination air release valve includes a stem having a first end and a second end, a float supported on the first end of the stem, a seal holder on a second end of the stem, a seal supported on the seal holder, a first flow restrictor defining a first flow restrictor opening, a nozzle received within the first flow restrictor opening, the nozzle defining a flow channel therethrough, the seal configured to abut against the nozzle and seal the flow channel, and a second flow restrictor defining a second flow restrictor opening.

### REFERENCE TO RELATED APPLICATIONS

This application claims one or more inventions that were disclosed in Provisional Application No. 63/626,263, filed Jan. 29, 2024, entitled “COMBINATION AIR RELEASE VALVE”. The benefit under 35 USC § 119(e) of the United States provisional application is hereby claimed, and the aforementioned application is hereby incorporated herein by reference.

### BACKGROUND OF THE INVENTION

### FIELD OF THE INVENTION

The invention pertains to the field of valves. More particularly, the invention pertains to air release valves.

### DESCRIPTION OF RELATED ART

Air release valves relieve excessive pressure in a system by releasing gas from the system. An air release valve has a body with an inlet and an outlet. Fluids (i.e., liquids and gases) can flow freely through the inlet, while a pressure sensitive closing mechanism selectively allows or prevents flow of gases through the outlet. Typically, the inlet is connected to a flow vessel such as a pipeline, while the outlet opens to or communicates with the open atmosphere or a system external to the flow vessel. Commonly, air release valves are placed at the high points of pipelines in order to prevent undesirable air pockets from forming in the pipeline. The air release valves allow gas to escape the pipeline through the outlet while the pipeline is filled with liquid until liquid buildup is detected in the body of the valve, indicating that the pipeline is full, triggering the pressure sensitive closing mechanism to shut off flow through the outlet. As the pipeline is used, some gas builds up in the body of the valve due to buoyancy, resulting in a gradual increase in pressure in the valve. When pressure increases above a certain threshold, the pressure sensitive closing mechanism opens to allow gas to escape the valve in a controlled flow through the outlet, thereby relieving pressure. In this manner, pressure is maintained within a safe range without the need for direct intervention from an operator of the valve. Combination air release valves, as opposed to conventional air release valves, additionally allow for gas to flow back into the pipeline in great volumes while the pipeline is emptied, thereby also acting as vacuum relief valves and preventing vacuum damage to the pipeline.

FIG. 1 illustrates a cross section of a conventional combination air release valve 10. The valve 10 has a body 12 defining a cavity 14, an inlet orifice 16, and an outlet orifice 18, the orifices 16, 18 connected by the cavity 14 at opposite ends of the body 12. Typically, a pipeline (not shown) or other flow vessel is in fluid connection to the inlet orifice 16 while outlet orifice 18 is in fluid connection to the open atmosphere or any type of gas treatment/storage system as desired by the operator. To restrict the flow of gases passing through the valve 10, a top flow restrictor 20 and a bottom flow restrictor 22 are located within the cavity 14, stacked on top of each other. The flow restrictors 20, 22 each have an opening to allow gases to controllably flow through the valve 10, the openings commonly having a smaller diameter than that of the outlet orifice 18. A nozzle 24 is located within the opening of the bottom flow restrictor 22, and a float 26 is located below the bottom flow restrictor 22 within the cavity 14. The float 26 has a sealing disc 28 which seals the opening of the nozzle 24 when the float 26 is pressed against the bottom flow restrictor 22.

The valve 10 remains in an open configuration under the force of gravity while the pipeline or other flow vessel is filling up with liquid, allowing for gases displaced by the liquid to flow into the inlet orifice 16 and out of the outlet orifice 18. Once the pipeline or other flow vessel is filled with liquid, some liquid will enter the valve 10 through the inlet orifice 16 and come into contact with the float 26. As the valve cavity 14 continues to fill with liquid, float 26 is pushed upwards, towards the outlet orifice 18, due to buoyancy, until the sealing disc 28 forms a seal with the nozzle 24, thereby stopping the flow of gases through the valve 10. As pressure in the closed cavity 14 increases due to gases mixed with the flowing liquid moving upwards into valve 10, the liquid is displaced until the float 26 loses buoyancy and moves downward, thereby opening the seal between the sealing disc 28 and the nozzle 24 and allowing built up gases to escape through the flow restrictors 20, 22 and the outlet orifice 18 until the level of liquid in the valve 10 rises again to close the valve 10. In this manner, pressure within the valve cavity 14 is maintained below a desired threshold.

The flow restrictors 20, 22, and the float 26, in valve 10 and other conventional designs, are substantially cylindrical and are made of plastic materials to reduce the weight of the valve 10 and the force required to actuate the components to operate the valve 10. However, for certain applications where the fluid is contaminated, such as applications dealing with sewage fluid, there is a concern that the integrity of the plastic material of the float 26 and flow restrictors 20, 22 can be compromised when the fluid comes into contact with those components, making the conventional valve 10 unsuitable for such applications. Contact between the fluid and the float 26 occurs constantly during normal operation of the valve 10, and contact between the fluid and flow restrictors 20, 22 tends to happen as fluid sloshes into the valve cavity 14 and against the wall of the body 12 as there isn't much distance between the float 26 and the flow restrictors 20, 22.

### SUMMARY OF INVENTION

A combination air release valve improves contamination and corrosion avoidance and/or resistance, increasing the distance between the flow restrictors and contaminated fluid.

In one embodiment, a combination air release valve includes: a valve body having a first end, a second end, and a first axis, the valve body defining a cavity, an inlet orifice at the first end in communication with the cavity, and an outlet orifice at the second end in communication with the cavity, the outlet orifice having an outlet orifice diameter; a first flow restrictor within the cavity, the first flow restrictor defining a first flow restrictor opening; a nozzle within the first flow restrictor opening, the nozzle having a flow channel therethrough; a seal holder supporting a seal, the seal configured to abut against the nozzle and seal the flow channel of the nozzle; a stem having a first end and a second end, the seal holder supported at the first end of the stem; a float supported on the second end of the stem; and a second flow restrictor within the cavity toward the outlet orifice with respect to the first flow restrictor, the second flow restrictor having an outer diameter and a second flow restrictor opening, the outer diameter greater than the outlet orifice diameter, wherein the inlet orifice, the outlet orifice, the first flow restrictor, the second flow restrictor, the nozzle, the seal holder, the stem, and the float are concentric with the first axis.

In another embodiment, a valve assembly for a combination air release valve includes a stem having a first end and a second end, a float supported on the first end of the stem, a seal holder on a second end of the stem, a seal supported on the seal holder, a first flow restrictor defining a first flow restrictor opening, a nozzle received within the first flow restrictor opening, the nozzle defining a flow channel therethrough, the seal configured to abut against the nozzle and seal the flow channel, and a second flow restrictor defining a second flow restrictor opening.

### BRIEF DESCRIPTION OF THE DRAWINGS

FIG. 1 shows a cross section of a conventional combination air release valve.

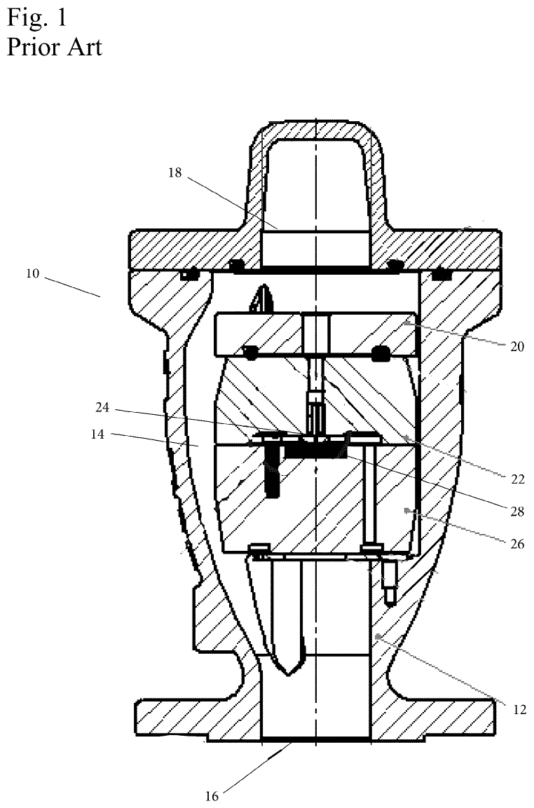

FIG. 2 shows a perspective view of a combination air release valve.

FIG. 3 shows a cross-section of the combination air release valve of FIG. 2 in a closed position.

FIG. 4 shows a cross-section of the combination air release valve of FIG. 2 in an open position.

FIG. 5 shows an enlarged view of a lower body portion of the combination air release valve of FIG. 3.

FIG. 6 shows an enlarged view of the combination air release valve of FIG. 3 beyond a spacer flange, including an upper portion of an upper body and upper cavity, and including a cover flange and an exhaust cover.

FIG. 7 shows an enlarged view of a sealing assembly of the combination air release valve of FIG. 6.

FIG. 8 illustrates an exploded perspective view of the combination air release valve of FIG. 2.

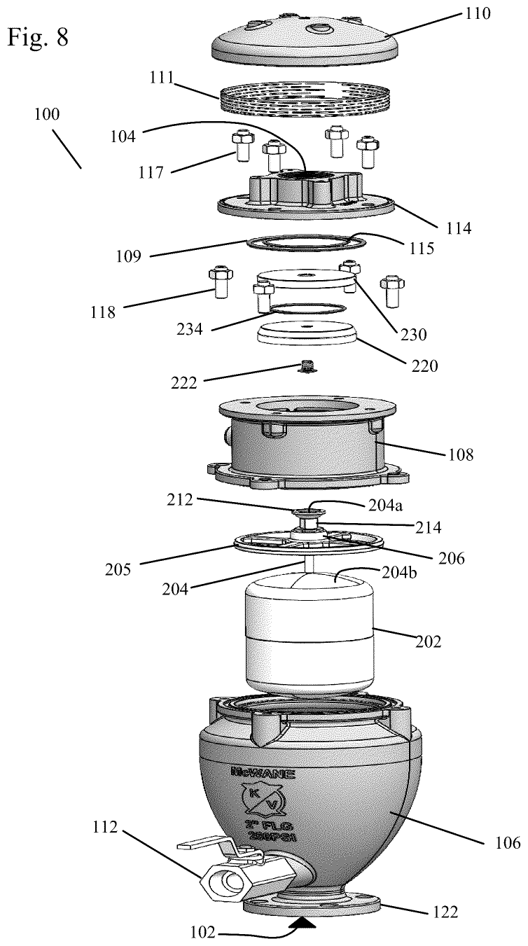

### DETAILED DESCRIPTION OF THE INVENTION

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “approximately” and “about”, when qualifying a quantity, shall mean the quantity with a tolerance plus or minus 10 percent of the quantity, unless otherwise specified.

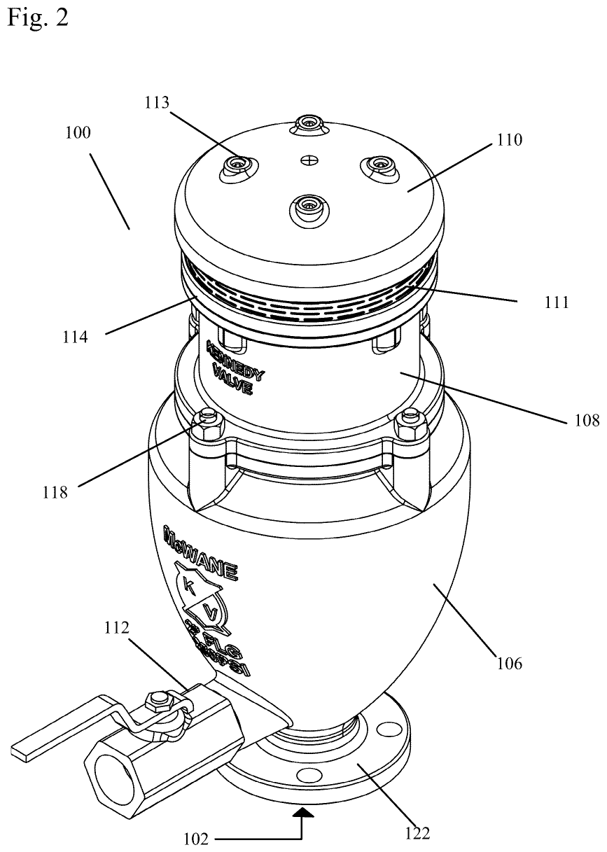

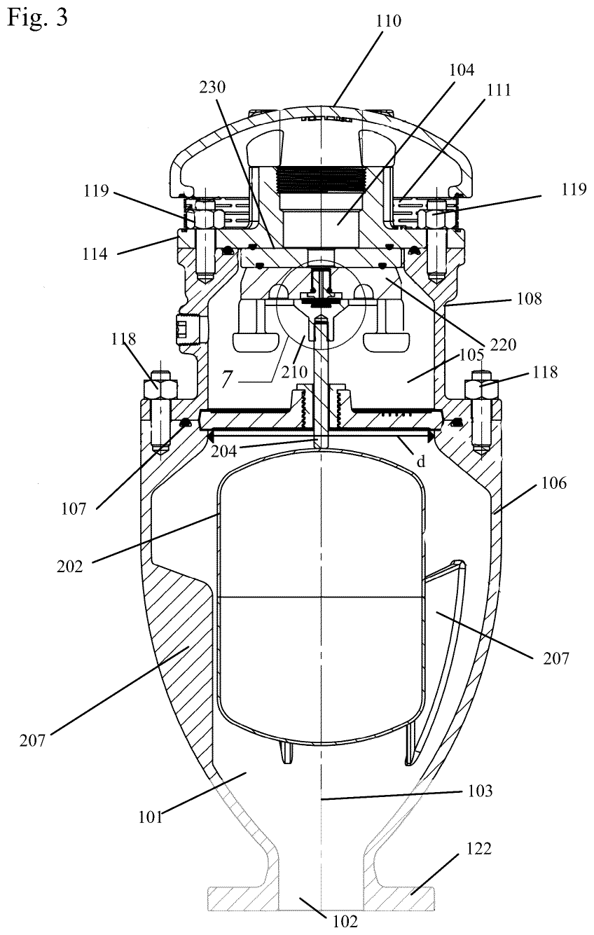

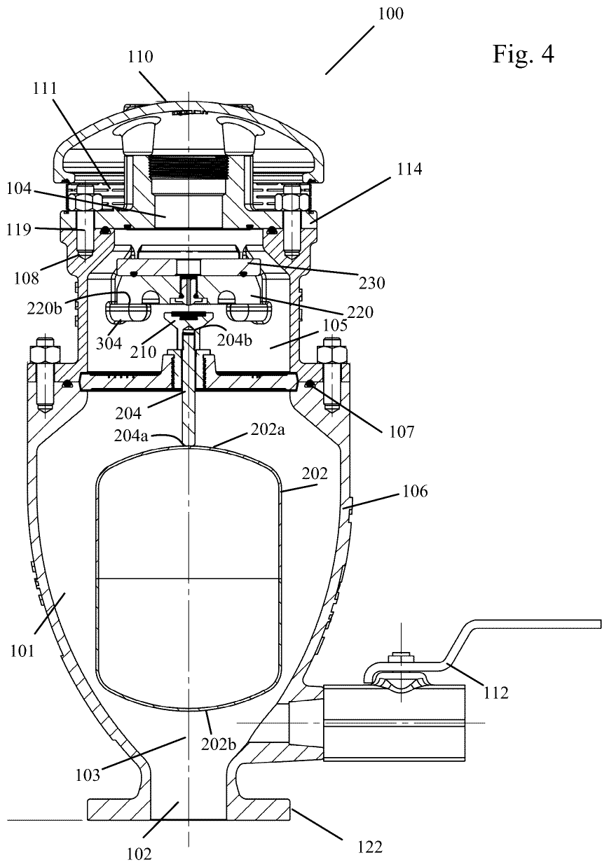

An improved combination air release valve is suitable for usage with contaminated fluids. FIG. 2 illustrates a perspective view of a combination air release valve 100. FIG. 3 illustrates a cross-section of the combination air release valve 100 in a closed position and FIG. 4 illustrates a cross-section of the combination air release valve 100 in an open position.

Referring to FIG. 2, FIG. 3, and FIG. 4, the combination air release valve 100 has a lower body 106 connected to an upper body 108. The lower body 106 has an inlet 102 that can be coupled to a flow vessel (not shown), such as a pipeline, by a flange 122 around the inlet 102. The lower body 106 can expand, e.g. conically, from the inlet 102 toward the upper body 108, defining a lower cavity 101. The upper body 108 can be secured to the lower body 106, e.g., with a first set of fasteners 118. A sealing ring 107 can be interposed directly between the lower body 106 and the upper body 108 to seal the junction. The upper body 108 can extend from the lower body 106, e.g., cylindrically, toward a cover flange 114, defining an upper cavity 105. The cover flange 114 can be secured to the upper body 108, e.g., with a second set of fasteners 119. The cover flange 114 has an outlet 104 that can be covered by an exhaust cover 110 as shown in FIG. 2. The exhaust cover 110 can have a perforated vent 111 to allow gases in the lower cavity 101 and/or the upper cavity 105 and/or the outlet 104 to escape the combination air release valve 100. The exhaust cover can be secured to the cover flange 114, e.g. with a third set of fasteners 113. The lower body 106, the upper body 108, the cover flange 114, and the exhaust cover 110 can be centered around an axis 103 extending through the center of the inlet 102 and the outlet 104. A flushing valve 112 can be mounted to the lower body 106 to allow an operator to flush the contents of the combination air release valve 100 during maintenance. The flushing valve 112 can be a ball valve or any other suitable type of valve now-known or future-developed.

Referring to FIG. 3 and FIG. 4, a continuous fluid path extends from the inlet 102, through the lower cavity 101, the upper cavity 105, the outlet 104, and the perforated vent 111. This continuous fluid path can be altered and/or restricted by a series of floats and other internal components, which work in coordination to achieve a desired release and intake of gas.

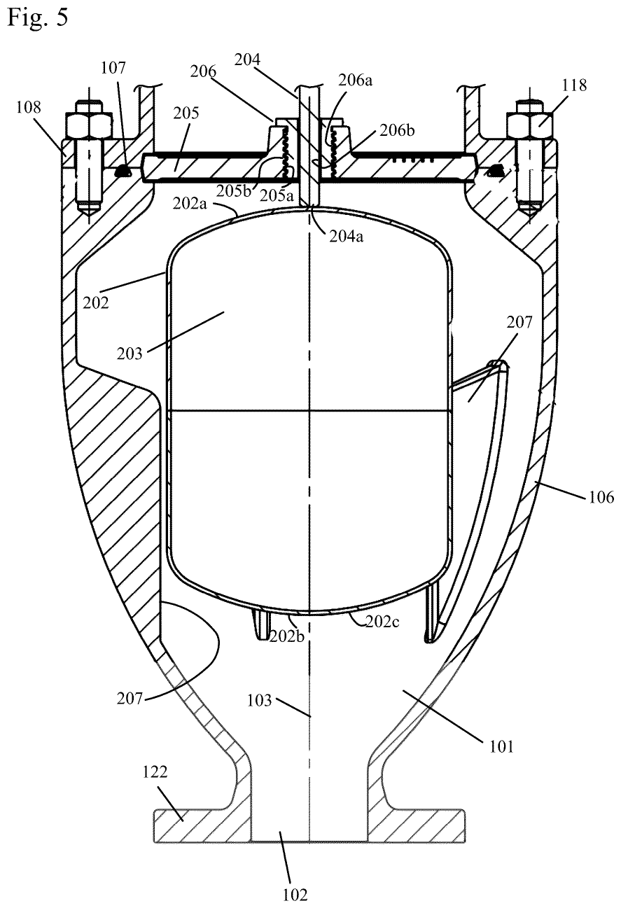

FIG. 5 shows an enlarged view of the lower body 106. Referring to FIGS. 3-5, the lower body 106 houses a bottom float 202 in the lower cavity 101 with a first end 202a and a second end 202b. The bottom float 202 can be made of a variety of materials, including stainless steel, which is suitable for exposure to sewage water or other fluids, to resist corrosion. The bottom float 202 can have a variety of shapes, including the substantially cylindrical shape with rounded ends as shown FIGS. 3-5. The bottom float 202 can be hollow to reduce weight and increase buoyancy. When appropriately installed to an operational flow vessel and/or flow system, the bottom float 202 can be buoyed toward the upper body 108 and lowered toward the inlet 102 along axis 103 with the rise and fall of the fluid level in the flow system and hence in the lower cavity 101.

The lower body 106 is relatively long between the inlet 102 and the upper body 108, relative to conventional air release valves. Likewise, the bottom float 202, which extends a majority of a length of the lower cavity 101 between the inlet 102 and the upper body 108, is long relative to comparable or similar floats in conventional air release valves. The greater length yields an increased standoff distance between liquid in the lower cavity 101 and the upper cavity 105, which in turn reduces and/or prevents contact between the liquids, which can contain sewage or other contaminants, and internal components housed in the upper body 108. Sewage and/or other contaminants can cause, promote, or accelerate degradation of the internal components housed in the upper body 108, or even obstruct proper movement and operation of these internal components.

One or more guides 207 can extend radially inward toward the axis 103, providing a surface extending parallel to the axis 103 along a length of the bottom float 202 between the inlet 102 and the upper body 108, to guide linear motion of the bottom float 202 on the axis 103. The guides 207 can also reduce fluid sloshing within the lower cavity 101 to further prevent contact of liquid and/or contaminants contacting internal components beyond the lower cavity.

The diameter and volume of the lower body 106 expanding from the inlet 102 toward the upper body 108 facilitates a reduction of liquid and/or contaminants contacting internal components in the upper cavity 105 by reducing the velocity of rising liquid in the axial direction toward the upper cavity 105. The bottom float 202 has a diameter larger than a diameter of the inlet 102, exposing a broad surface (e.g., surface 202c) to fluid entering the lower cavity 101 through the inlet 102. As the fluid enters and rises in the lower cavity 101, the fluid pushes the bottom float 202 toward the upper cavity 105 and expands radially outward. Toward the junction of the lower body 106 and the upper body 108, the diameter of the lower body 106 tapers to a diameter of the upper body 108 (see diameter d), restricting passage between the lower body 106 and the bottom float 202 for any splashed liquid and/or contaminants to pass into the upper cavity 105 or even reach the junction of the lower body 106 and the upper body 108.

A stem 204 includes a first end 204a engaging the first end 202a of the bottom float 202, and extends concentrically with the axis 103 to a second end 204b. Linear movement of the stem 204 with the bottom float 204 can be stabilized or guided by a stem guide 206, which can be mounted concentrically with the center axis 103 within a spacer flange 205. The spacer flange 205 is permeable or open, such that gas can easily pass beyond the spacer flange 205 from the lower cavity 101 to the upper cavity 105. The spacer flange 205 can be held at the junction of, and between, the lower body 106 and the upper body 108. The spacer flange 205 can include a central hole 205a that can receive and hold the stem guide 206. For example, the central hole 205a of the spacer flange 205 can have internal (female) threads 205b and the stem guide 206 can have external (male) threads 206a, such that the stem guide 206 can be threaded into the central hole 205a of the spacer flange 205. The stem guide 206 has a central hole 206b sized to receive, pass, and stabilize or guide the stem 204.

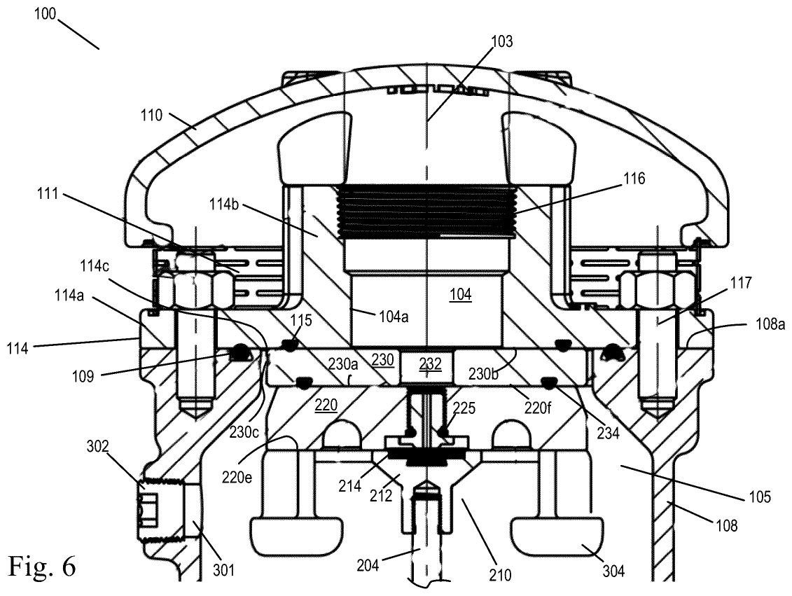

FIG. 6 shows an enlarged view of the combination air release valve 100 beyond the spacer flange 205, including an upper portion of the upper body 108 and upper cavity 105, and including the cover flange 114 and the exhaust cover 110. Referring to FIGS. 3, 4, and 6, a scaling assembly 210 is connected to the second end 204b of the stem 204.

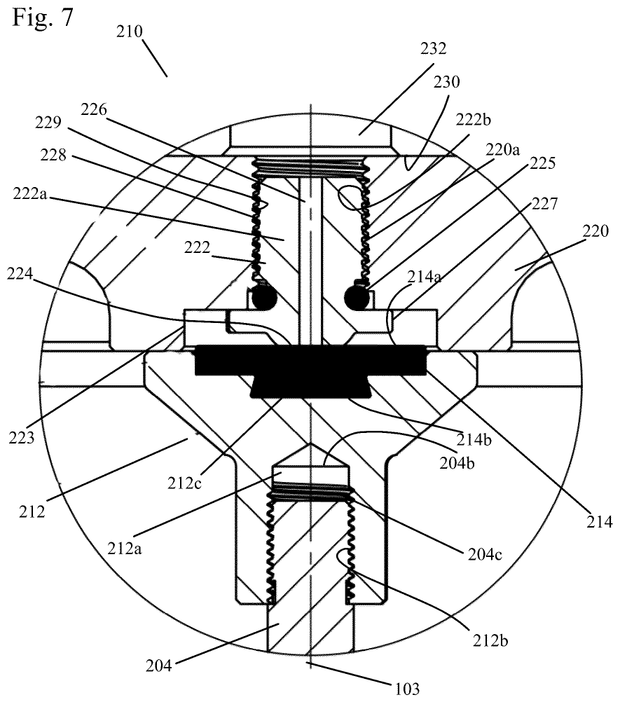

FIG. 7 shows an enlarged view of the sealing assembly 210. A seal holder 212 is secured to the stem 204 by now-known or future-developed means. In the depicted embodiment, the stem 204 includes external (male) threads 204c that couple with internal (female) threads 212b of a bore 212a within the seal holder 212. The sealing assembly 210 also includes a sealing element 214 to seal a flow path through a first flow restrictor 220 (also referenced as a middle float). A first surface 214a of the sealing element 214 faces toward the flow restrictor 220. The scaling clement 214 can be secured to the seal holder 212 by now-known or future-developed means. In the depicted embodiment, a dovetail shaped recess 212c of the seal holder 212 receives a correspondingly shaped protrusion of the sealing element 214. While other shapes and sizes can be suitable, the seal holder 212 is Y-shaped in this embodiment to provide sufficient and appropriate structure for the threaded bore 212a and additional width or diameter to support a greater surface area of the sealing element 214. The sealing element 214 has a first sealing element sealing surface 214a facing the flow restrictor 220 and a second sealing element scaling surface 214b on the dovetail shaped protrusion on an opposite side of the sealing element 214 from the first sealing element sealing surface 214a. The first sealing element sealing surface 214a is greater in diameter and/or surface area than that of the second sealing element scaling surface 214b.

The sealing assembly 210 can abut and/or support the first flow restrictor 220. The first flow restrictor 220 can be generally or approximately puck-shaped or disk-shaped, with a through hole 220a for receiving a nozzle 222 having a flow path 226 therethrough. The through hole 220a can be central and/or concentric with axis 103. The flow path 226, when open, allows for controlled flow of gases through the first flow restrictor 220. When the valve 100 is in the closed position as shown in FIG. 3, the sealing element 214, (namely, e.g., the first sealing element sealing surface 214a of the sealing element), abuts a nozzle sealing surface 224 of the nozzle 222 to form a fluid-tight seal, and prevent flow of gases through the flow channel 226. The first sealing element sealing surface 214a can be substantially or approximately flat and/or smooth to facilitate mating and sealing against the nozzle sealing surface 224 of the nozzle 222. When the seal element 214 is sealed against the nozzle sealing surface 224, the seal holder 212 can abut and/or support non-nozzle portions of the first flow restrictor 220.

The nozzle 222 can be integrated as a continuous portion of the first flow restrictor 220, though manufacturing the nozzle 222 as a separate and assemble-able component of the first flow restrictor 220 facilitates use of a material for the nozzle 222 that promotes sealing against the sealing element 214 (such as stainless steel or another material with contamination and/or corrosion resistance properties) while a more buoyant material can be used for the other portions of the flow restrictor 220. In the depicted embodiment, the nozzle 222 has a body 222a, stop flanges 227, and the nozzle sealing surface 224. The body 222a has external (male) threads 228. The external threads 228 of the nozzle 222 are threaded into internal (female) threads 229 of the through hole 220a such that the stop flange 227 of the nozzle 222 abuts a deep end of a recess or counterbore 223 of the first flow restrictor 220. An O-ring 225 can be located between the stop flange 227 and the body 222a to seal between the nozzle 222 and a radially inward facing wall defining the hole 220a in which the nozzle 222 is located. The nozzle sealing surface 224 can extend out of the counterbore 223, or the sealing element 214 can be configured to extend into the counterbore 223 to promote stronger contact between the nozzle sealing surface 224 and the sealing element 214.

In some embodiments, one or more support elements 304 extend from the first flow restrictor 220 beyond the bottom surface 220e of the first flow restrictor 220 toward the inlet 102 such that the first flow restrictor 220 and the second flow restrictor 230 are prevented from falling down into the cavity 101 when the buoyancy force acting on the bottom float 202 does not push the sealing assembly 210 into the first flow restrictor 220 (e.g., transitioning from the closed position to the open position). The support elements 304 may also contribute in maintaining the first flow restrictor 220 and the second flow restrictor 230 centrally aligned along the central axis 103 during operation of the combination air release valve 100. The first flow restrictor 220 and the second flow restrictor 230 can be made of HDPE plastic or other plastics with similar properties to reduce weight and costs.

Referring back to FIG. 3, FIG. 4, and FIG. 6, the first flow restrictor 220 can support a second flow restrictor 230 (also referenced as an anti-surge float), with the supporting force forming a seal between a top surface 220f of the first flow restrictor 220 and a bottom surface 230a of the second flow restrictor 230, the seal being facilitated by a sealing ring 234 located in a recessed groove on at least one of the top surface 220f of the first flow restrictor 220 and the bottom surface 230a of the second flow restrictor 230. The second flow restrictor 230 has a hole 232 that can be centered on the central axis 103 and can be connected to the flow path 226.

Still referring to FIG. 3, FIG. 4, and FIG. 6, the upper body 108 has a top opening sized to fit the second flow restrictor 230. The top opening is enclosed by the cover flange 114. The cover flange 114 can include a flange portion 114a and an outlet portion 114b. The flange portion 114a can be fastened to the upper body 108 by fasteners 117 or other fastening means known in the art. An inner sealing ring 115 can seal between the flange portion 114a and the second flow restrictor 230 in the closed position. An outer sealing ring 109 can also seal between the flange portion 114a and the upper body 108. The inner sealing ring 115 can be positioned in a recessed groove on the bottom surface 114c of the flange portion 114a, and the outer scaling ring 109 can be positioned in a recessed groove on a top surface 108a of the upper body 108. The outlet portion 114b defines outlet 104 and can include an internal pipe thread 116 such that an exhaust pipe can be coupled to the outlet 104 if desired. An exhaust cover 110 having a perforated vent 111 can be included to redirect and decelerate gases flowing out of the outlet 104. As shown in FIG. 2, the exhaust cover 110 may be fastened to the top cover flange 114 by fasteners 113 that pass through holes in the exhaust cover 110 and thread into corresponding threads (not shown) in the outlet portion 114b of the cover flange 114. The upper body 108 can also include a side opening 301 to allow flushing of the combination air release valve 100 during maintenance. The side opening 301 can be sealed by a plug 302 during normal operation of the valve 100.

In operation, the combination air release valve 100 can start in an open position with gas flowing freely through inlet 102 and outlet 104, with the pipeline (not shown) empty. Filling the pipeline displaces a large amount of gas which flows through the inlet 102 and out of the outlet 104 into the atmosphere. Flow of the gas may increase in speed as more liquid is introduced in the pipeline, until the gas flows at supersonic speeds between the inlet 102 and the outlet 104. Bernoulli's principle does not apply once flow of gas is supersonic, and a reversed version of the principle applies, such that flow of gas accelerates as cross-sectional area increases, reducing pressure as a result. For this reason, when gas flow passes a speed of Mach 1, a pressure differential is created between the large opening of the outlet 104 above the anti-surge float or second flow restrictor 230 and the relatively smaller opening or hole 232 defined by the second flow restrictor 230. As a result of the pressure differential, the anti-surge float or second flow restrictor 230 moves up towards the exhaust cover 110, such that the second flow restrictor 230 seals around the opening 104a of the outlet 104, such that fluid can only flow through the smaller diameter hole or opening 232 defined by the second flow restrictor 230. It is noted that the second flow restrictor 230 is maintained in sealing around the opening 104a of the outlet 104 by the pressure of the gas flowing through the opening 232 of the second flow restrictor 230. The opening 232 of the second flow restrictor 230 having a smaller diameter than the outlet 104 results in a much more controlled and slower flow of gas, slowing down the rate at which the pipeline fills up, such that the combination air release valve 100 eventually closes completely, reducing the effect of “water hammer”, which is defined as an abrupt change in velocity of an incompressible fluid causing a huge spike in pressure, capable of causing damage.

The pipeline continues filling at slowed rate through the opening 232 of the second flow restrictor 230 and into the outlet 104 until the pipeline is completely full. When the pipeline is full, liquid then enters the combination air release valve 100 through the inlet 102, and contacts the bottom float 202.

Because the bottom float 202 is hollow and preferably made of stainless steel, the bottom float 202 rises due to buoyancy and forces the stem 204 up such that the sealing element 214 abuts against the nozzle 222, sealing the flow path 226 through the nozzle 222, as well as pushing the first flow restrictor 220 and the second flow restrictor 230 to seal against each other and the outlet opening 104a. When enough liquid is in the lower body 106 of the combination air release valve 100, the entire assembly of the combination air release valve 100 is sealed and the combination air release valve 100 is in a fully closed position with no possible route for gas to escape, as shown in FIG. 3. Because the combination air release valve 100 is closed, a residual amount of gas is left in the lower body 106 of the combination air release valve 100 above the liquid.

During operation of the pipeline, it is to be expected that some gas bubbles will be mixed with the fluid. This can be due to many factors, and especially in the case of sewage wastewater, for example, a significant amount of methane gas can be emitted due to chemical processes such as anaerobic decomposition of the organic matter present in the fluid. Gas bubbles will rise to the high points of the pipeline, where the combination air release valve 100 is installed, and build up in the combination air release valve 100. Over time, the pressure of the gas contained in the combination air release valve 100 may increase to be greater than the pressure of the fluid in the combination air release valve 100 which causes displacement of the fluid in the combination air release valve 100 towards the inlet 102. At this point, if the pressure of the gas is not relieved, the gas may eventually re-enter the pipeline through the inlet 102 disrupting flow and potentially increasing the overall pressure in the pipeline to dangerous levels.

When the level of fluid in the combination air release valve 100 drops due to displacement, the bottom float 202 loses buoyancy and moves down or away from the exhaust cover 110, therefore lowering the seal holder 212 and opening the flow path 226 through the nozzle 222 as a result, as shown in FIG. 4. Gas is thereby allowed to escape in a controlled manner through the nozzle 222, and through the first flow restrictor 220 and the second flow restrictor 230, and ultimately out through the outlet 104 into the atmosphere. While gas escapes the combination air release valve 100, pressure of the gas inside the combination air release valve 100 decreases and the level of the fluid rises as a result. Eventually, the fluid level rises enough to seal the nozzle 222 again, closing the combination air release valve 100 and restarting the cycle. This way, pressure within the combination air release valve 100 is maintained within a certain range that allows for safe and effective operation of the pipeline.

The valve is configured as a combination air release valve 100, meaning it also functions as a vacuum relief valve. When the pipeline is emptied, pressure inside the combination air release valve 100 and the pipeline rapidly decreases. As pressure of the gas within the combination air release valve 100 drops to about atmospheric pressure and the liquid level drops below the inlet 102, the floats drop down away from the exhaust cover 110 and allow gas to enter the combination air release valve 100 through the outlet 104 and flow through the inlet 102 into the pipeline, thereby relieving vacuum in the pipeline and preventing vacuum damage.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A combination air release valve comprising:
a valve body having a first end, a second end, and a first axis, the valve body defining a cavity, an inlet orifice at the first end in communication with the cavity, and an outlet orifice at the second end in communication with the cavity, the outlet orifice having an outlet orifice diameter;
a first flow restrictor within the cavity, the first flow restrictor defining a first flow restrictor opening;
a nozzle within the first flow restrictor opening, the nozzle having a flow channel therethrough;
a seal holder supporting a seal, the seal configured to abut against the nozzle and seal the flow channel of the nozzle;
a stem having a first end and a second end, the seal holder supported at the first end of the stem;
a float supported on the second end of the stem; and
a second flow restrictor within the cavity toward the outlet orifice with respect to the first flow restrictor, the second flow restrictor having an outer diameter and a second flow restrictor opening, the outer diameter greater than the outlet orifice diameter,
wherein the inlet orifice, the outlet orifice, the first flow restrictor, the second flow restrictor, the nozzle, the seal holder, the stem, and the float are concentric with the first axis.

2. The combination air release valve of claim 1, further comprising a flow restrictor support element extending from the first flow restrictor, the flow restrictor support element configured to limit movement of the first flow restrictor and the second flow restrictor along the first axis towards the inlet orifice.

3. The combination air release valve of claim 2, wherein the flow restrictor support element extends from the valve body into the cavity.

4. The combination air release valve of claim 1, further comprising a spacer flange having an opening concentric with the first axis, wherein the stem is configured to pass through the opening of the spacer flange.

5. The combination air release valve of claim 1, wherein the float and the nozzle each include stainless steel, and the first flow restrictor and the second flow restrictor each include plastic polymer.

6. The combination air release valve of claim 1, further comprising a float guide in the cavity, the float guide configured to limit movement of the float away from the first axis.

7. The combination air release valve of claim 6, wherein the float guide extends from the valve body into the cavity towards the first axis.

8. The combination air release valve of claim 1, wherein the cavity has a first diameter proximate to the first end and a second diameter proximate to the second end, the first diameter greater than the second diameter.

9. The combination air release valve of claim 1, further comprising a cover flange coupled to the valve body at the second end.

10. The combination air release valve of claim 9, further comprising a perforated vent coupled to the valve body and surrounding at least a portion of the cover flange.

11. The combination air release valve of claim 10, further comprising an exhaust cover mounted to the perforated vent and the cover flange.

12. A valve assembly for a combination air release valve comprising:
a stem having a first end and a second end;
a float supported on the first end of the stem;
a seal holder on a second end of the stem;
a seal supported on the seal holder;
a first flow restrictor defining a first flow restrictor opening;
a nozzle received within the first flow restrictor opening, the nozzle defining a flow channel therethrough, the seal configured to abut against the nozzle and seal the flow channel; and
a second flow restrictor defining a second flow restrictor opening.

13. The valve assembly of claim 12, wherein the nozzle further comprises a sealing surface, the sealing surface being adjacent to the flow channel and configured for engagement with the seal.

14. The valve assembly of claim 13, wherein the nozzle further comprises a body and a stop flange.

15. The valve assembly of claim 14, wherein the body comprises external threads; and the first flow restrictor further comprises internal threads in the first flow restrictor opening; the external threads of the nozzle being threaded to the internal threads of the second flow restrictor opening.

16. The valve assembly of claim 13, wherein the first flow restrictor opening includes a counterbore adjacent the seal holder and a pilot hole adjacent the first flow restrictor.

17. The valve assembly of claim 16, wherein the nozzle further comprises a body received within the pilot hole and a stop flange received within the counterbore.

18. The valve assembly of claim 16, wherein:
the seal holder has a diameter greater than an inner diameter of the counterbore; and
the seal has an outer diameter less than the inner diameter of the counterbore.
